(19) United States
(12) Patent Application Publication
(10) Pub. No.: US 2005/0077175 A1
(43) Pub. Date: Apr. 14, 2005

(54) Miniaturized analytical system

(76) Inventors: Friedhelm Eisenbeiss, Weiterstadt (DE); Bernd Stanislawski, Frankfurt (DE); Thomas Greve, Darmstadt (DE); Renate Bender, Darmstadt (DE); Roland Hergenroder, Dortmund (DE); Gunther Weber, Dortmund (DE); Benedikt Grass, Werl (DE); Andreas Neyer, Iserlohn (DE); Matthias Johnck, Munster (DE); Dirk Siepe, Dortmund (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/000,419

(22) Filed: Dec. 1, 2004

Related U.S. Application Data
(63) Continuation of application No. 10/009,486, filed on Dec. 13, 2001.

(30) Foreign Application Priority Data
Jun. 16, 1999 (DE) 199 27 533.5

(51) Int. Cl. G01N 27/26

(52) U.S. Cl. 204/400; 156/290; 29/592.1

(57) ABSTRACT

The present invention relates to a process for producing a microstructured analytical system including providing at least two plastic components, wetting at least one component, aligning the components, pressing and joining the components together and curing an adhesive.

This application is a continuation of U.S. application Ser. No. 10/009,486, filed 13 Dec. 2001, which was the National Stage of International Application No. PCT/EP00/05206, filed 6 Jun. 2000.

The invention relates to the production and structure of miniaturized analytical systems, in particular those having apparatuses for control and measurement of electrical conductivity.

Miniaturized analytical systems, in particular those having a microfluidic channel structure are increasingly becoming of importance. There is particular interest in miniaturized analytical systems, which offer opportunities for electrophoretic separation and analysis of samples.

Analytical units which can be used for such applications generally consist of a baseplate (substrate) and a cover, between which are situated microchannel structures, electrodes and other required functionalities, such as detectors, reactors, valves etc.

The demands which must be made of a microfluidic analytical system include sufficient stability with respect to mechanical, chemical, electrical and thermal effects. For the channel structures, mechanical stability means, in particular, dimensional and volumetric stability, which is an important prerequisite for, for example, quantitatively reproducible sample delivery. Internal pressure stability of the microchannels is also required with respect to the use of pumps, for example, for charging the microchannels. The materials used must obviously be chemically inert to the medium transported in the channels. If electrodes are introduced into the channel, these must be able to be positioned with high accuracy (a few μm) in the channel, in order to be able to give reproducible results when used, for example, as a detector electrode. In addition, it is also a prerequisite that the contact surfaces within the channel are free from contaminants. The electrodes must also permit low internal resistance and potentially high current flow. This applies in particular to what are termed power electrodes by which, depending on the medium used, an electrokinetic flow can be generated within the channels. Finally, the electrodes should be easily connectable.

A material which is frequently used for producing analytical units of this type is silicon dioxide or glass. However, a disadvantage of these materials is that they are not suitable for inexpensive mass production of the analytical systems. Plastic-based materials are considerably more suitable for this purpose. Components such as the substrate and cover which contain the actual microstructures can be produced inexpensively and highly reproducibly by known processes, such as hot embossing, injection moulding or reaction moulding.

In contrast, for sealing the resultant open microstructures with covers, there have hitherto been no methods suitable for mass production for plastic components. This applies in particular to microcanal structures in which, in addition, metal electrodes must be positioned at any points within a closed channel structure and in which all four sides of a channel must consist of the same material.

EP 0 738 306 describes a process for sealing microchannel structures in which a dissolved thermoplastic is spun onto the structured polymer substrate. This dissolved thermoplastic has a lower melting temperature than the parts to be stuck together. The cover and substrate are thermally bonded at 140° C. The surface of the channel (3 side walls) thus consists of the thermoplastic adhesive. If the adhesive is spun onto the cover, at least one side of the channel is wetted by the adhesive.

In U.S. Pat. No. 5,571,410, microfluidic structures are produced in Kapton™ by laser ablation and are welded to a KJ®-coated Kapton™ film. In this case also, at least one side wall of the channel structure consists of a second material.

Becker et al. (H. Becker, W. Dietz, P. Dannberg, “Microfluidic manifolds by polymer hot embossing for μTAS applications,” Proceedings Micro Total Analysis Systems 1998, 253-256, Banff, Canada) report on the production of microfluidic channels in hot-embossed PMMA which are sealed by chemically supported bonding to PMMA covers.

WO 97/38300 describes a process in which a cover is wetted by a homogeneous polydimethylsiloxane (PDMS) adhesive layer and is stuck to a polyacrylic-based fluidic structure.

Although all of the abovementioned processes permit microchannel structures to be produced by joining a substrate to a cover, all four walls of the channel do not, however, consist of the same material. In addition, they do not permit the integration of electrodes which have direct contact with the medium in the channels when all four sides of a channel simultaneously consist of the same material.

EP 0 767 256 describes a process for integrating electrodes into microstructures, but this process does not permit liquid-insulated contacting, since for the photochemical deposition of the metal in the channels, these must be rinsed with metal salt solutions.

A method for integrating electrodes at any desired points within a microstructured channel having the possibility for liquid-insulated contacting of the electrodes has been described by Fielden et al. (P. R. Fielden, S. J. Baldock, N. J. Goddard, L. W. Pickering, J. E. Prest, R. D. Snook, B. J. T. Brown, D. I. Vaireanu, “A miniaturized planar isotachophoresis separation device for transition metals with integrated conductivity detection”, Proceedings Micro Total Analysis Systems '98, 323-326, Banff, Canada). The authors have moulded a microfluidic channel structure in silicone (PDMS) and press this mechanically against a platen provided with electrodes (copper). The channels are thus delimited by two different materials. To keep the resultant channels closed, a constant mechanical pressure must be maintained. The pressure on the silicone cushion readily causes deformations of the channel structures to occur in this system. In this case also, at least one side wall of the channel structure consists of a second material.

It is an object of the present invention, therefore, to provide an improved microfluidic analytical system whose substrate and cover consist of polymeric organic materials and are firmly joined to one another and into which electrodes can be introduced at any desired position with the possibilities for liquid-insulated contacting. If electrodes are to be integrated into the analytical system, an additional object is that the electrodes can be integrated at any desired position in the channel system and are not damaged or detached by the bonding process.

It has been found that the combination of a novel process for producing noble metal coatings which have good adhesion to plastic surfaces using a special bonding technique for joining two plastic components permits production of microfluidic analytical systems, more precisely continuous-flow units for microfluidic analytical systems, having the properties discussed in the prior art and in the objective.

The present invention therefore relates to a process for producing microstructured continuous-flow units for analytical systems which essentially comprises the following steps:

a) providing at least one substrate and at least one cover made of plastic, of which at least one component is microstructured;

b) wetting either substrate or cover with adhesive, with the regions of the channels remaining free from adhesive;

c) aligning the components;

d) pressing the components together;

e) curing the glue.

It is a preferred embodiment of the inventive process to use in step a) at least one component which is provided with electrodes.

It is also a preferred embodiment of the inventive process to perform the adjustment in step c) using sputtered optical alignment markers.

The invention further relates to a microstructured continuous-flow unit for analytical systems which was produced by the inventive process.

A preferred embodiment of the inventive continuous-flow unit is a system which has electrodes which are in free contact with the interior of the channel system.

A preferred embodiment of the inventive continuous-flow unit is a system which has electrodes having an adhesive coating of chromium oxide and a coating of noble metal.

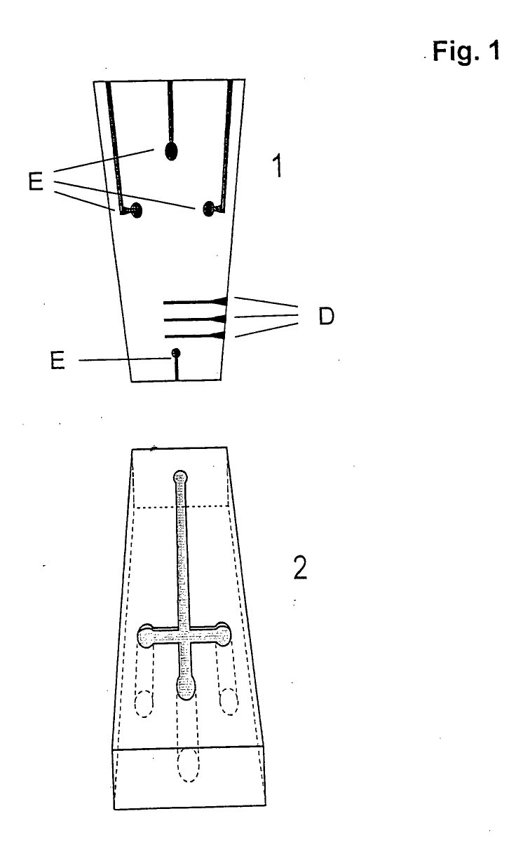

FIG. 1 shows by way of example a possible structure of a continuous-flow unit having two components.

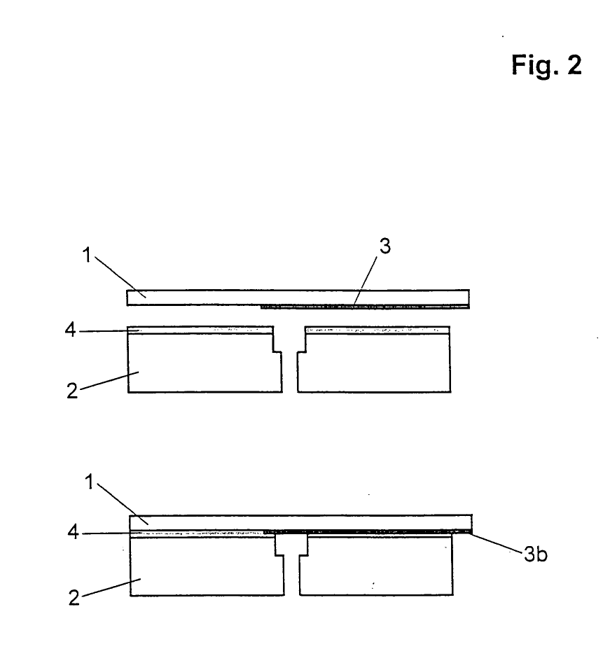

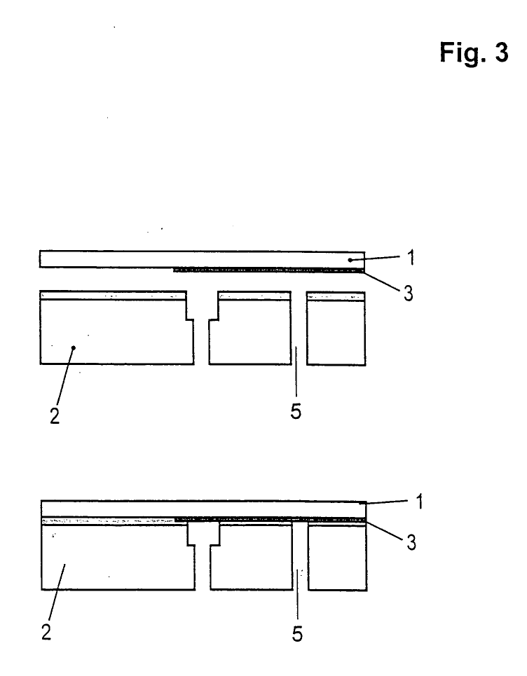

FIGS. 2 and 3 show two possibilities for contacting the electrodes.

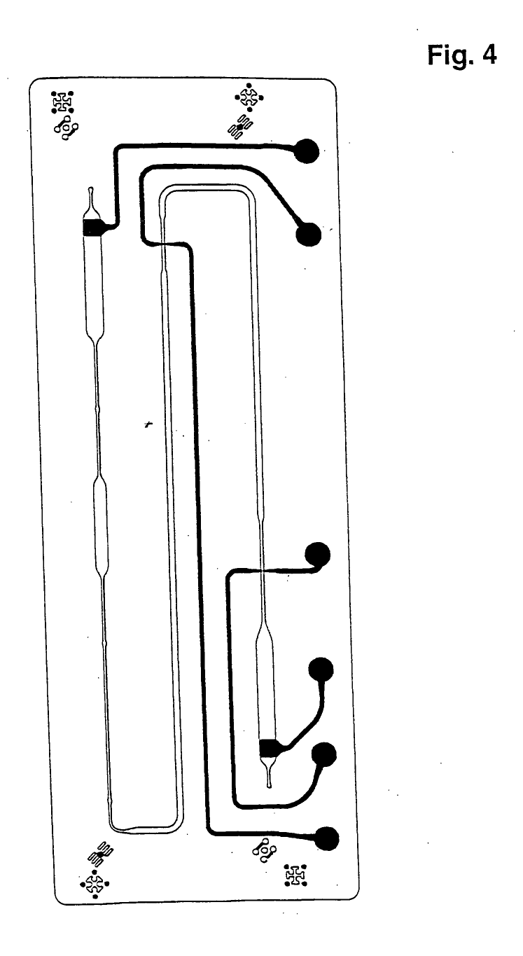

FIG. 4 shows a component having optical alignment markers.

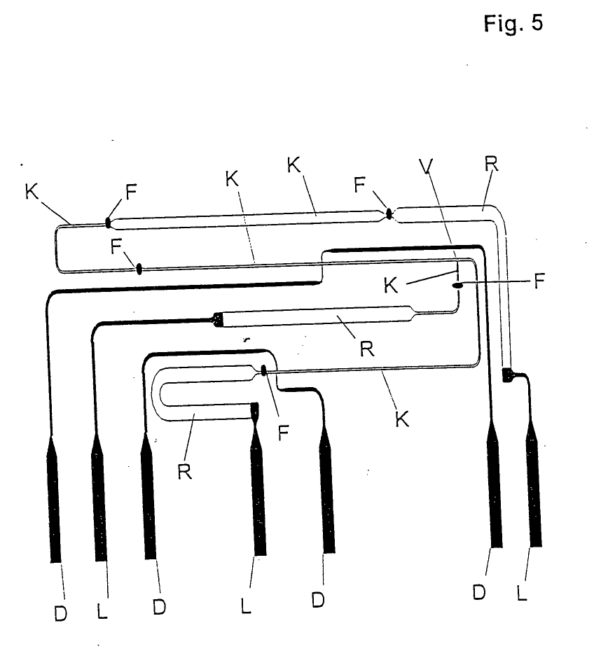

FIGS. 5 to 11 are described in more detail in the examples.

Microfluidic or microstructured analytical systems generally consist of a continuous-flow unit which has at least the channel system and, optionally, recesses for integrating peripheral devices, and peripheral devices such as detectors, fluidic connections, reservoirs, reaction chambers, pumps, control devices, etc., which can be integrated into the continuous-flow unit or connected thereto. Continuous-flow units for microfluidic analytical systems having apparatuses for measuring and controlling electrical conductivity are inventive systems in which, by joining together at least two components, for example substrate and cover, microchannel structures are produced which can be sealed liquid-tightly and/or gas-tightly. Substrate and cover for this purpose are firmly bonded to one another. In addition, these systems can comprise electrodes at any desired point of the channel system, which electrodes are in free contact with the interior of the channel, that is penetrate into the channel system. The invention therefore relates to microstructured continuous-flow units for analytical systems, in a broader sense therefore, to microstructured analytical systems.

The microfluidic analytical systems can be adapted for various applications by varying differing parameters, for example the channel structure, the connection of other systems, such as pumps, feedlines, etc., any desired arrangement of the electrodes. Particularly preferably, the inventive continuous-flow units for analytical systems are for applications in the field of electrophoretic separation and analysis, for example for capillary electrophoresis or isotachophoresis and for micropreparative syntheses or derivatizations of substances.

The analytes can be detected after exit from the analytical system or directly in the system, that is to say in the continuous-flow unit. Preferably, optical or electrochemical detection methods are integrated into the continuous-flow unit. Electrochemical detection is performed using suitably provided and positioned electrodes.

For the input or output of optical power into or from a channel, predominantly processes are used in which optical fibres are positioned directly in front of a glass capillary (for example “classical CE”). For laser-induced fluorescence measurement (LIF) in microstructured channels in planar two-dimensional systems, processes have been established in which the excitation laser light is focused onto the channel via free-beam optics and the fluorescence is detected via a free-beam optical system (microscope, possibly confocal, having an optical detector, for example CCD camera).

The components of the continuous-flow unit of the analytical systems preferably consist of commercially available thermoplastics such as PMMA (polymethyl methacrylate), PC (polycarbonate) polystyrene or PMP (polymethylpentene), cycloolefinic copolymers or thermosetting plastics, for example epoxy resins. More preferably, all components, that is to say substrates and covers, of a continuous-flow unit, consist of the same material.

The components can be produced by methods known to those skilled in the art. Components which comprise microstructures can be produced, for example, by established processes, such as hot embossing, injection moulding or reaction casting. Particular preference is given to the use of components which can be duplicated by known methods for mass production. Microstructured components can have channel structures of cross sectional areas between 10 and 250,000 μm².

The electrodes which are introduced into the inventive continuous-flow units are typically used for generating a flow of ions or for detection purposes. They must have a sufficient strength of adhesion to the plastic components. This is of importance both for joining the individual components and for the later use of the analytical systems.

The planned use of the analytical system is particularly critical for the choice of the electrode material. Since systems having microchannel structures and integrated electrodes are essentially used in the analytical sector, the electrodes should consist of chemically inert materials, for example noble metals (platinum, gold).

The choice of materials of this type and methods for their application are known to those skilled in the art. Typically, plastic surfaces are metallized by electrochemical deposition of the metals from metal salt solutions. For this purpose it is generally customary, in a multistep process, firstly to pretreat the plastic surface chemically or mechanically, to apply a discontinuous primer and finally to carry out the electrochemical deposition. Descriptions of these metallization methods may be found, for example, in U.S. Pat. No. 4,590,115, EP 0 414 097, EP 0 417 037 and in Wolf and Gieseke (G. D. Wolf, H. Gieseke, “Neues Verfahren zur ganzflächigen und partiellen Metallisierung von Kunststoffen” [Novel process for complete and partial metallization of plastic surfaces] Galvanotechnik 84, 2218-2226, 1993). The wet-chemical processes share the fact that relatively complex pretreatment processes are necessary to achieve sufficient adhesion strengths.

DE 196 02 659 describes the application, with high adhesive strength, of copper to multiphase polymer blends by vaporizing or sputtering. A reason mentioned for the good adhesion is the composition of the polymer blends. According to this the blends must comprise polyarylenesulphides, polyimides or aromatic polyester.

The effect of plasma pretreatments to achieve improved adhesion properties of metals to plastic surfaces is summarized by Friedrich (J. Friedrich, “Plasmabehandlung von Polymeren” [Plasma treatment of polymers], kleben & dichten 41, 28-33, 1997) as exemplified by various commercially available thermoplastics. The general purpose of the plasma pretreatment is to generate polar functional groups on the polymer surface, so that an increased adhesion strength of metallic layers results. By way of example, the effect of chromium as an adhesive layer in the metallization of plastics is described. The cause of the good adhesion of chromium, for example, mentioned, is an interaction of polar groups, for example carbonyl groups or ester groups, with chromium 3d orbitals.

Particularly preferably, the electrode structures are generated on the plastic components using a two-layer method. For this purpose, according to the invention firstly an adhesion-promoting layer of chromium oxide is produced. It has been found that chromium oxide, in contrast to noble metals, has excellent adhesion properties on plastic surfaces. In addition, chromium oxide, in contrast to elemental chromium and other transition metals, is considerably more resistant to redox processes. The noble metal, for example platinum or its alloys or gold, is then applied to the chromium oxide adhesion layer.

Chromium oxide and the noble metal layer to be deposited thereon is preferably selectively applied to plastic substrates in the lift-off method or using what is termed the shadow-mask method or the structuring of metallic layers initially applied on the whole surface. These processing techniques are standard processes in microstructure engineering. Below, the working steps required for the two-layer method are described in brief for the said process.

Lift-off process: the plastic component to be selectively metallized is coated with a photoresist. This photoresist must not etch, or etch only slightly, the plastic part to be metallized. For PMMA, PS and PC, for example, a photoresist from Allresist, Berlin (AR 5300/8) has proved to be suitable. After illumination and development of the structure to be metallized, the metallic layers are applied in a sputtering unit. The chromium oxide layer is applied during the sputtering process by introducing oxygen into the sputtering system argon plasma typically used. The sputtering target used is a conventional chromium target. Typical chromium oxide layer thicknesses are 10-50 nm. Alternatively, a chromium oxide target can be used directly. Sputtering platinum or its alloys or gold is carried out directly afterwards under standard conditions, that is to say in the argon plasma. It has proved advantageous for the adhesion strength of the chromium oxide layer, moreover, before sputtering the chromium oxide, to carry out back-sputtering of the plastic in an oxygen/argon (approximately 5% by volume/95% by volume) plasma. In the actual lift-off process, the photoresist still present and, together with this, the metal layer situated on the resist is detached from the plastic component in a developer from Allresist (AR 300-26).

Shadow-mask method: the plastic part to be selectively metallized is covered with what is called a shadow mask. This has recesses in the areas to be metallized. The metal layers are sputtered through these similarly to the lift-off method. The advantage of this method is the markedly simple procedure, since the photoresist processing is omitted. The adhesion strength of the electrodes is comparable with the lift-off technology.

Structuring planar metal layers: a metal layer is firstly applied, similarly to the above-described sputtering process, over the whole surface of a plastic part to be metallized selectively. This metal layer is structured in subsequent process steps, either by selective erosion using, for example, laser ablation (gold and platinum) or, for example, by selective wet-chemical etching. For structuring using wet-chemical etching, a photoresist (Hoechst AG, Germany; AZ 5214) is first applied to the metal layer, illuminated and developed. Gold is then removed in the illuminated areas in cyanide solution. The non-electrically-conducting chromium oxide layer remains behind. The remaining photoresist is finally removed with a developer (for example AR 300-26, Allresist, Berlin).

The adhesion strength of electrodes produced with chromium and also chromium oxide as adhesion layer using the sputtering method has been tested using tear-off tests. The adhesion strength of the chromium oxide layers is significantly greater. The metal layers that have been produced using chromium oxide as adhesion layer are also markedly more resistant in ultrasonic treatment in alkaline solution compared with metal layers which were produced using chromium as adhesion layer.

After production and preparation of individual components, these are joined together by the inventive process. Preferably, a component, the substrate, is microstructured and provided with rear-side bore holes or recesses for filling the channels and/or contacting the electrodes. In addition, the use of a so-called sealing lip, that is to say an elevation on the substrates which completely encloses the channel structures with a height between typically 0.5 and 5 μm, has proved to be highly advantageous with respect to the adhesion process. The other component, the cover, serves for covering and, for example, is provided with the electrodes in the case of electrophoretic analytical systems. In this case the cover according to the invention is termed electrode cover. Since the inventive process relates not only to the production of the analytical system measurement and control apparatus, certain applications of the systems can require functionalization of the components which deviates from this preferred arrangement. In this case, for example, more than two components, for example two covers and one substrate etc., can be joined together in order to generate channel structures which lie one above the other, or other functionalities, such as detection systems, reaction chambers etc., can be integrated into the components. According to the invention, all parts of the continuous-flow unit of the analytical system which are joined together using a bonding process are termed components. They can be microstructured, provided with electrodes or have other functionalities. A subdivision of the components into substrates and covers or electrode covers, if the respective component is provided with electrodes, only serves for the more detailed description of the embodiment of the specific components and does not represent any restriction with respect to other properties of the components, such as microstructuring etc., or their combination with one another.

In a preferred embodiment, the analytical system consists of two components. One component, for example the substrate, is microstructured and has the channel system and other recesses for the connection of other functionalities, for example fluidic connections. This component is produced using an injection-moulding process. The bore holes for filling the channels and/or contacting the electrodes are generated directly in this case by corresponding dents in the mould.

The second component, in this case an electrode cover, has no microstructuring at all. Instead, all the electrodes are disposed on this component. This division considerably simplifies the production of the two components. It is not necessary to subject the microstructured component used in the injection-moulding process to other processing steps. The electrodes are sputtered onto the flat, unstructured component.

The components are joined together according to the invention with high precision. It is important for the analytical performance that none of the walls comprises highly reactive plastic, that is to say unpolymerized or molten plastic. This means that the adhesive must not run into the channels and coat their surfaces, since this can alter the surface properties of the channels. It has been found that this leads, for example, to increased adhesion of analytes, for example proteins, to the canal regions which are wetted with adhesive. This in turn influences the separation quality of the analytical systems. Similarly, sticking adhesive to the electrodes impairs their functionality.

It is also of great importance that the volume of the channels is not changed, as would occur, for example, by the uncontrolled ingress of adhesive. According to the invention the channel, to improve the sensitivity of detection, is preferably constricted in the vicinity of the detection electrodes. As a result it is important precisely in these areas that no adhesive passes into the channel.

To join the components together, according to the invention an adhesive is preferably applied firstly to the microstructured component at the points at which no structuring is present. The layer thickness is between 0.5 and 10 μm, preferably between 3 and 8 μm. Typically, it is applied using a flat roller application known from printing technology.

In a preferred embodiment, a thin adhesive film is applied here via a structured metallic screen roll which takes up a defined volume of adhesive to a second unstructured roll which is coated with a polymer. From this in turn application is performed directly onto the structured substrate in such a manner so as preferably to give an adhesive thickness between 3 and 8 μm on the unstructured surface of the substrate. Depending on the plastic (substrate material) used, the transfer between the plastic roll and the substrate is influenced by any viscosity increase in the adhesive (prepolymerization). An important advantage of this process is that the substrate need not be positioned relative to the roll bearing the adhesive and nevertheless adhesive is only applied to the unstructured regions of the substrate. If too much adhesive is applied, when the cover and substrate are pressed together, adhesive will flow into the channel. If in parts insufficient adhesive has been applied, leaks in the channel structure result. This bonding method requires a flatness of the components of preferably less than approximately 5 μm/cm of component length.

The adhesive used must not etch the surface of the components or etch it only slightly, in order that the electrodes during the adhesion process are not detached or interrupted by the adhesive. Preferably, therefore, the adhesive used is the product NOA 72, thiol acrylate from Norland, New Brunswick N.J., USA. This glue is cured photochemically. However, other types of glues can also be used for the process, for example thermally curing glues which comply with the above conditions.

After the adhesive has been applied, the second component having the thin-layer electrodes is positioned appropriately to the substrate for example on an exposure machine and pressed on. For this purpose, preferably the substrate together with the applied adhesive is fixed in the exposure machine in the position otherwise provided for silicon wafers. Preference is given to the use of thick glass plates as pressing surface, since in this manner the positioning and photochemical curing of the glue can be carried out by illumination with an Hg lamp (emission wavelength 366 nm). The electrode cover is fixed in the position provided for the exposure mask by holding it with a vacuum apparatus having a milled glass plate. Since both the electrode cover and the glass plate used for holding the cover are transparent, the cover can be aligned with respect to the substrate through this arrangement. If the cover extends beyond the substrate, this cover can also be held mechanically.

For the adhesion process, typically in addition to optomechanical alignment with the assistance of optical alignment marks, the cover can also be positioned on the substrate passively mechanically using a push-in apparatus, optomechanically without special alignment marks, or electromechanically using electrical marks (contacts).

FIG. 4 shows a component having inventively preferred optical alignment marks in the corners for the optomechanical alignment. In addition, electrodes (black) and a channel structure may be seen. It has been found that the metallic alignment marks on the cover can be applied together with the electrodes in the same process step, that is to say preferably can be sputtered, that is to say no additional expenditure is necessary. The corresponding counterstructures on the substrate also require no additional processing, since these are introduced into the substrate together with the channel structures in a moulding step.

For the optomechanical alignment, at least one component must consist of a transparent plastic. Using the inventively applied alignment marks, the two components are positioned with respect to one another at an accuracy of at least ±10 μm, typically even ±2 μm (for example, theoretical to actual position of the detector electrode) and pressed together. The high position accuracy supports the achievement of reproducible analytical results. The adhesive is then polymerized by a UV lamp. After turning off the vacuum for holding the cover or releasing the mechanical fixing the continuous-flow unit is removed from the exposure machine.

In another preferred embodiment, a component is provided with adhesive by means of a process known in printing (pad printing). The component provided with the electrodes for this purpose is wetted with the glue for this purpose on the regions which, when the two components are combined, must not lie over a channel or be electrically contacted. Microstructured components are wetted such that no adhesive passes into the channel structure or other recesses. Pad printing is a structured glue application. Adhesive is stored in a negative mould of the substrate. Via a typically silicone pad, this adhesive is taken up in a structured manner and applied, for example, onto the cover in such a manner that the regions which later form a wall of a fluidic channel are not wetted with the adhesive. The component having the channel structures is then, as described above, positioned in a suitable manner to its counterpiece and pressed on. Curing is performed as described above.

A structured glue application using spray methods (for example microdrop methods) or using screen-printing methods is possible, provided that the lateral resolution of the glue discharge is sufficient.

Pressing on the second component or pressing together the components, for the purposes of the invention, means that the components are brought suitably into contact with one another. In order to achieve, after curing, a permanent bonding of the components, it is generally not necessary to exert a large force, that is to say to press the components together very firmly.

If the curing process of the glue is carried out outside the alignment apparatus used for positioning the cover and substrate, the metallized cover and the substrate, after they have been aligned to one another, can be initially attached by laser welding. After this the composite is removed from the alignment apparatus and the adhesive used is cured in a separate exposure apparatus or an oven. This procedure means a process acceleration and simplification, since the curing need no longer be performed in the alignment apparatus.

Since the thermoplastic materials preferably used are very largely transparent to laser light in the visible and near-infrared wavelength region, laser welding in this wavelength range requires an absorber layer for absorbing the optical power at the interface between cover and substrate. This absorber layer is applied simultaneously with the application of the power electrodes or detector electrodes. For example, the electrode cover, during sputtering of the electrodes with noble metal, can additionally be sputtered at further points with a noble metal layer as absorber layer.

Welding an electrode cover which is provided with 200 nm thick platinum electrodes and also comprises additional platinum surfaces for absorbing the laser power to a substrate (base material PMMA) is performed using diode laser radiation (mixture of wavelengths of 808, 940 and 980 nm) at a power of 40 watts and a focus diameter of 1.6 mm. The platinum layer is destroyed during welding.

Alternatively, it is also possible to use a substrate or cover filled, for example, with carbon black particles, as absorber. This last-mentioned procedure, however, has the disadvantage that then at least one channel wall consists of another material. The possibilities for input into the channel or output from the channel of optical power for optical detection purposes are also restricted thereby.

The inventive process makes it possible firstly to produce closed microchannel structures whose walls consist of one material and in which electrodes can be positioned at any desired positions within the channels. Structured components (substrates) can be provided liquid-tightly and gas-tightly with, for example, electrode covers. By using chiefly commercially available plastics and simple processing steps, the inventive analytical systems can be produced inexpensively and in large numbers. By means of the inventive process for joining or bonding, the components are wetted with adhesive such that after the joining no adhesive passes into the interior of the channel system, that is to say into the channels, the walls or onto electrodes or other apparatuses penetrating into the channel system. As a result the separation quality and analytical sensitivity of the systems are improved. The inventively produced continuous-flow units for analytical systems having a measuring and control apparatus for electrical conductivity comply with all requirements which must be made of such a system:

They exhibit high dimensional and volumetric stability of the channels.

As a result of the strength of the adhesive bonds they are pressure-stable in the interior of the channels.

There is great variety with respect to the plastics which can be used.

Chemically inert materials can be used for components and electrodes.

All four channel walls preferably consist of the same material.

The electrodes can be positioned at any desired points of the channels with an accuracy of generally ±10 μm, even of ±2 μm.

The contact surfaces of the electrodes are free from contamination due to adhesive.

The electrodes can easily be connected.

The systems exhibit low internal resistance and permit potentially high current densities.

FIG. 1 shows by way of example the two functionalized components of a microstructured analytical system. Component 1, the electrode cover, has four electrodes (E) for generating an ion flow and three electrodes (D) for electrical or electrochemical detection. Component 2 is microstructured. On joining together the two components, the ends of the electrodes of the cover enter precisely the channels of the substrate.

FIGS. 2 and 3 show two possibilities for contacting the electrodes.

In FIG. 2, the cover (1) with the electrode (3) projects beyond the microstructured component (2) having the adhesive layer (4). After joining together the two components, the electrode can be contacted via its external region (3b).

In FIG. 3, cover (1) and substrate (2) have the same dimensions. After they are joined together, the electrodes cannot be contacted at the side. Instead, in the substrate there is an additional bore hole (5) via which the electrodes (3) can be contacted, for example, using a sprung pin.

Even without further explanations, it is assumed that a person skilled in the art can utilize the above description to the broadest extent. The preferred embodiments and examples are therefore to be understood only as descriptive disclosure which is in no way limiting in any sense.

Complete disclosure of all applications, patents and publications listed above and below, and of the corresponding application DE 199 27 533, submitted on 16.06.1999, is incorporated by reference into this application.

### EXAMPLES

The following separations were carried out using an analytical system corresponding to FIG. 5. FIG. 5 shows the channel system having the channel sections K, the reservoirs R, the branch point V, the fluidic connections F, and the leading electrodes L and the detection electrodes D.

1. Detection of Benzoic Acid in Tomato Ketchup

A two-stage separation of the sample material was carried out. In the first step, isotachophoretic separation was carried out with the TE and LE buffers, and in the second step capillary electrophoresis was carried out using the TE and CE buffers.

Separation Conditions:

LE (leading electrolyte): 10 mmol/l HCl+β-alanine+0.2%
methyl hydroxyethyl cellulose, pH=3.9

TE (terminal electrolyte): 10 mmol/l of propionic acid+
ε-aminocaproic acid, pH=4.7

CE (capillary

electrophoresis buffer): 10 mmol/l of propionic acid+
ε-aminocaproic acid+0.2% methyl hydroxyethyl cellulose, pH=4.2

Current 1: 8 μA

Current 2: 7 μA

Sample:

Ketchup Tortex® (Poland)

Sample preparation: 1 g of ketchup is added to 100 ml of a 0.1 mmol/l sodium hydroxide solution and treated for 10 min in an ultrasonic bath. The mixture is then filtered and appropriately diluted.

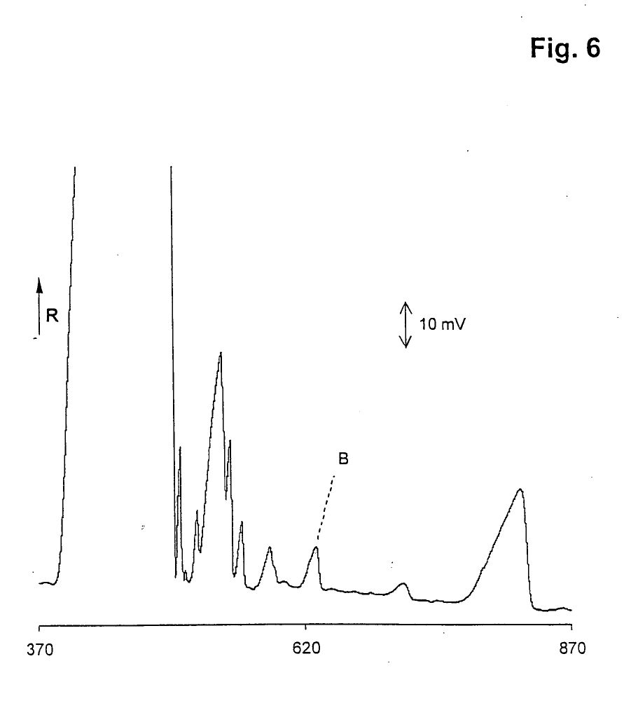

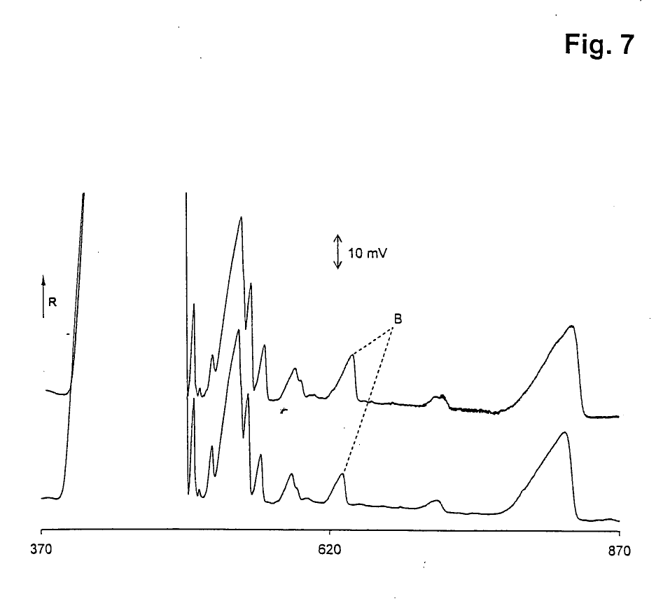

10 μl of sample were applied. The result of the separation is shown in FIGS. 6 and 7. The time in seconds is given on the x-axis and the resistance R on the y-axis. FIG. 6 shows the separation after the first separation step, isotachophoresis. FIG. 7 shows the result of separation by capillary electrophoresis after a preceding isotachophoresis. The upper line shows 500-fold diluted ketchup, the lower line shows 500-fold diluted ketchup after an addition of 10 μmol/l of benzoic acid. The peaks labelled B show benzoic acid. The area under the peak has markedly increased in comparison with the upper curve.

It was thus found that the lower limit of detection for benzoic acid in a difficult matrix is markedly below 10 μmol/l.

2. Analysis of Wine

Separation Conditions:

LE: 10 mmol/l HCl+β-alanine+0.1% methyl
hydroxyethyl cellulose pH=2.9

TE 1: 5 mmol/l of caproic acid+histidine, pH=6.0

TE 2: 5 mmol/l of glutamic acid+histidine, pH=5.0

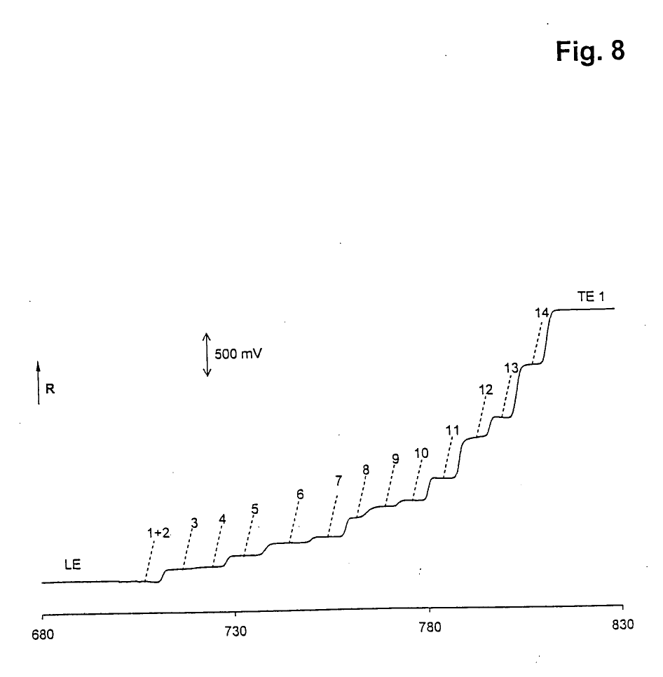

FIGS. 8 to 10 show the separation of the samples below. The time in seconds is given on the x-axis and the resistance R on the y-axis.

FIG. 8:

0.2 mmol/l of sulphate, sulphite, phosphate, malonate, tartrate, citrate, malate, lactate, gluconate, aspartate, succinate, acetate, ascorbate, sorbate

Current 1: 10 μA

Current 2: 10 μA

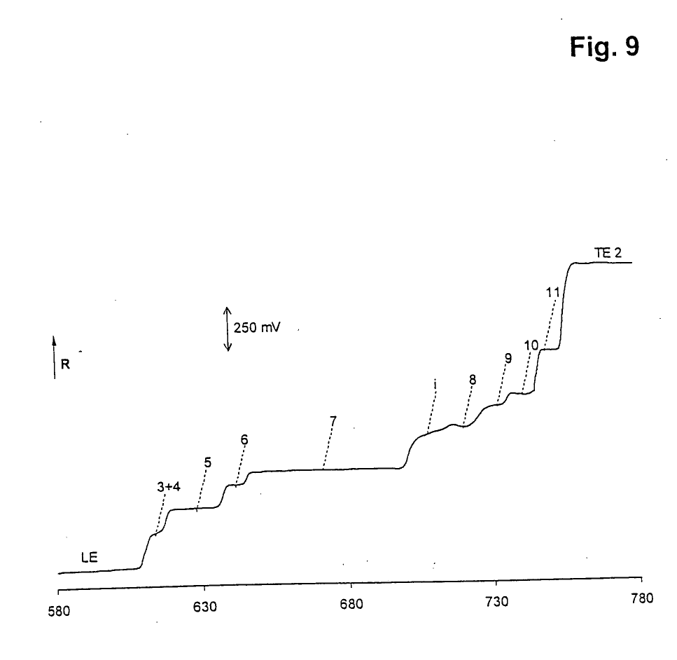

FIG. 9:

20-fold diluted white wine+0.25 mmol/l of aspartate

Current 1: 20 μA

Current 2: 10 μA

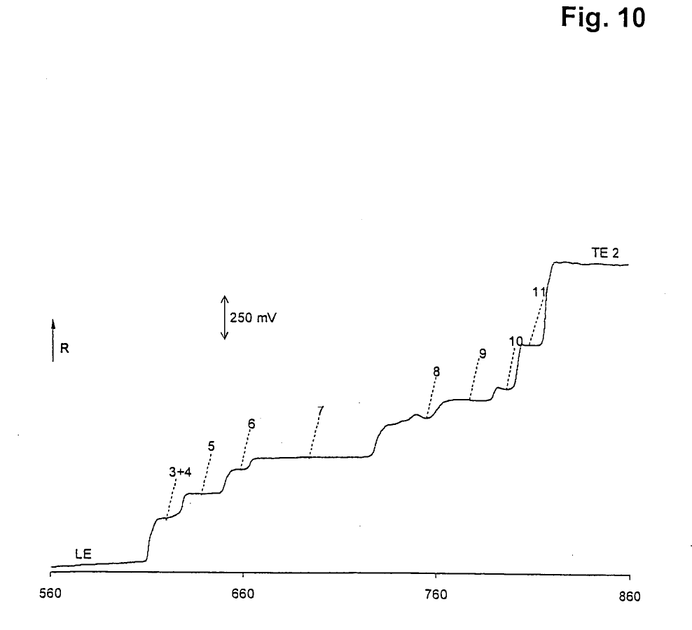

FIG. 10:

20fold diluted red wine+0.25 mmol/l of aspartate

Current 1: 20 μA

Current 2: 10 μA

The numbering of FIGS. 6 to 8 indicates the following constituents:

1=sulphate

2=sulphite

3=phosphate

4=malonate

5=tartrate

6=citrate

7=malate

8=lactate

9=gluconate

10=aspartate as internal standard

11=succinate

12=ascorbate

13=acetate

14=sorbate

i=impurities

3. Determination of Glutamate in Soup Preparations

Separation Conditions:

LE: 10 mmol/l of histidine chloride+histidine+0.2% methyl hydroxyethyl cellulose, pH=6.1

TE: 8 mmol/l of morpholinoethanesulphonic acid+histidine, pH=6

Current 1: 10 mA

Current 2: 10 mA

Samples:

1—VITANA® broth: 2500-fold dilute

2—vegetable soup KNORR®: 625-fold dilute

3—French soup MAGGI®: 625-fold dilute

4—Beef broth KNORR®: 5000-fold dilute

5—Seasoning mixture KOTÁNYI®: 1250-fold dilute

6—Goulash soup CARPATHIA®: 1250-fold dilute

7—Seasoning mixture KNORR®: 2500-fold dilute

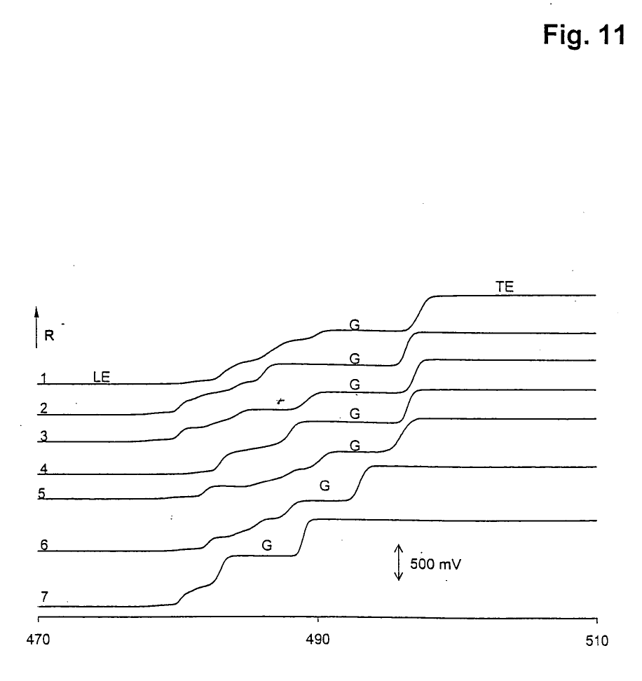

Analysis of the samples is shown in FIG. 11. The time in seconds is shown on the x-axis and the resistance R on the y-axis. G means glutamic acid.

1. A process for producing a microstructured analytical system comprising:
providing at least two plastic components, wherein at least one component is microstructured and forms at least one channel;
wetting at least one component with an adhesive;
aligning the components;
pressing and joining the components together when joined surfaces of the components are in a parallel relation; whereby an interior of the at least one channel is not coated with the adhesive after joining the components; and
curing the adhesive.

2. A process according to claim 1, wherein the at least one component comprises electrodes.

3. A process according to claim 1, wherein aligning is performed using sputtered optical registration markers.

4. A microstructured analytical system produced by a process according to claim 1.

5. A microstructured analytical system according to claim 4, wherein the system comprises electrodes in free contact with the interior of the channel.

6. A microstructured analytical system according to claim 4, wherein electrodes are coated with a chromium oxide and a noble metal.

7. A process according to claim 1, wherein the adhesive is applied with a thickness of 0.5-10 μm.

8. A process according to claim 1, wherein the system further comprises a detector, a fluidic connection, a reservoir, a reaction chamber, a pump or a control device.

9. A process according to claim 1, wherein the adhesive is applied to an unstructured region of the component.

10. A process according to claim 3, further comprising applying electrodes at generally the same time as the optical registration markers.

11. A process according to claim 1, wherein wetting is by flat rolling, pad printing, spraying, or screen printing.

12. A microstructured analytical system comprising:
at least two plastic components, wherein at least one plastic component comprises at least one electrode, and the at least one electrode comprises a chromium oxide and a noble metal.

13. A system according to claim 12, wherein the electrode comprises a coating of the chromium oxide and a coating of the noble metal.

14. A process according to claim 1, wherein the at least two plastic components are thermoplastic.

15. A process according to claim 1, wherein the at least two plastic components are thermoset plastic.

16. A process according to claim 1, wherein the at least two plastic components are polymethylpentene.

17. A process according to claim 1, wherein the at least two plastic components are polymethyl methacrylate.

18. A process according to claim 1, wherein the adhesive is thiol acrylate.
